(19) United States
(12) Patent Application Publication
(10) Pub. No.: US 2026/0295353 A1
(43) Pub. Date: Oct. 1, 2026

(54) HYBRID GOLF SYSTEM AND METHOD FOR LOCATING GOLF BALL OR MARKER AT BALL POINT ON FIELD UNDER THE HYBRID GOLF SYSTEM

(71) Applicant: GOLFZON CO., LTD., Seoul (KR)

(72) Inventor: Jae Yoon OK, Goyang-si, Gyeonggi-do (KR)

(73) Assignee: GOLFZON CO., LTD., Seoul (KR)

(21) Appl. No.: 18/881,295

(22) PCT Filed: Jul. 5, 2023
(86) PCT No.: PCT/KR2023/009454

§ 371 Date: Jan. 5, 2025

(30) Foreign Application Priority Data
Jul. 6, 2022 (KR) 10-2022-0083064

(51) Int. Cl. A63B 67/02; A63B 24/00; A63B 57/30; A63B 71/06

(52) U.S. Cl. CPC A63B 67/02; A63B 24/0021; A63B 57/353; A63B 71/0622; A63B 2024/0031; A63B 2024/0096; A63B 2220/05; A63B 2220/806

(57) ABSTRACT

The present invention has been made in view of the above conventional problems, and it is an object of the present invention to provide a hybrid golf system and a method for locating golf ball or marker at ball point on the real field in the hybrid golf system, when playing on an actual field following play on a virtual golf course using a screen golf system in the hybrid golf system, a camera sensing system can be used to detect and control a locator so that it can position a golf ball or a marker at a ball point on the field that corresponds to a ball position on the virtual golf course.

### TECHNICAL FIELD

The present invention relates to a hybrid golf system configured such that an approach shot is taken or a putt is made as real golf play on a real field when a virtual ball lands on or around a green during virtual golf play using a virtual golf simulation apparatus and a method for locating golf ball or marker at ball point on the real field in the hybrid golf system.

### BACKGROUND ART

Recently, as the golf population has increased, a so-called screen golf system that allows golfers to practice golf and enjoy virtual rounds of golf using a virtual golf simulation system has emerged.

Such a screen golf system is a system in which a screen capable of displaying a virtual golf course is installed indoors, and when a golfer hits a golf ball toward the screen, the speed, direction, and the like of the golf ball are detected and the trajectory of the golf ball is displayed on the screen, and the system has been technologically evolving in terms of providing users with a realistic feeling of playing a round of golf on a real golf course, beyond the level of simply playing a game of golf indoors.

Conventional screen golf systems have limitations in providing users with the realism of playing a round of golf on a real golf course because a simulation image of a virtual golf course and the trajectory of a ball on the virtual golf course is realized only through the screen installed in front of the user hitting the ball.

In order to overcome this limitation, a so-called hybrid golf system that goes beyond the conventional screen golf systems and provides the same level of realism as playing a round of golf on a real golf course but can be realized in a much smaller space than the real golf course has emerged.

The hybrid golf system is a combination of a real field where real golf can be played and a screen golf system, wherein some of the golf play on a hole may be performed on a virtual golf course implemented by the screen golf system and the rest of the play may be performed as real golf on a real field.

For example, in the case of a par-4 hole, a tee shot and a second shot are taken through virtual golf simulation on the virtual golf course through the screen golf system, and a third shot may be taken and a putt may be made in the same manner as playing golf on a real golf course after a user moves to the real field.

Prior art documents related to the hybrid golf systems include KR10-2013-0030536, KR10-2012-0036155, KR10-2012-0036156, and KR10-2012-0009933.

In such a hybrid golf system, the system accurately specifies a golf ball position on an field corresponding to a position where the user's virtual ball is seated on the virtual golf course so that the user can take a golf shot at the corresponding golf ball position on the field.

Conventionally, a laser pointer was mainly used to specify the golf ball position on the field corresponding to the virtual ball position on the virtual golf course.

That is, a hybrid golf system according to a prior art calculates the golf ball position on the field corresponding to the user's virtual ball position on the virtual golf course, and a laser pointer installed around the field indicates the golf ball position on the field. Accordingly, the user can place a golf ball at the position indicated by the laser pointer and take a golf shot.

However, there are many problems with the method of indicating the golf ball position using the laser pointer as described above.

In order for the laser pointer to indicate the exact golf ball position, the size of the field must be reduced or a lot of laser pointers must be installed, which has a problem of reducing the realism of golf play on the field.

If the field is formed widely, a number of laser pointers must be installed around the field to effectively indicate the golf ball position, and such laser pointers can interfere when playing the field.

In addition, a separate control module must be equipped to control the many laser pointers, the installation cost increases significantly, and the maintenance of the laser pointers is expensive.

### PRIOR ART DOCUMENTS

Korean Patent Publication No. 10-2013-0030536

Korean Patent Publication No. 10-2012-0036155

Korean Patent Publication No. 10-2012-0036156

Korean Patent Publication No. 10-2012-0009933

### DISCLOSURE

### Technical Problem

The present invention has been made in view of the above conventional problems, and it is an object of the present invention to provide a hybrid golf system and a method for locating golf ball or marker at ball point on the real field in the hybrid golf system, when playing on an actual field following play on a virtual golf course using a screen golf system in the hybrid golf system, a camera sensing system can be used to detect and control a locator so that it can position a golf ball or a marker at a ball point on the field that corresponds to a ball position on the virtual golf course.

### Technical Solution

In accordance with an aspect of the present invention, the above and other objects can be accomplished by the provision of a hybrid golf system comprising: a screen golf module that allows a user to play golf in a virtual golf course and is provided on one side of a field on which the user plays actual golf; a simulator provided in the screen golf module that implements a virtual golf simulation image according to the virtual golf course and the user's golf play; a camera sensing system including a plurality of cameras provided to detect the field; a locator that moves on the field and locates a golf ball or a marker at a user's ball point; and a controller that calculates a position on the field corresponding to a ball position on the virtual golf course of the user played through the simulator as the ball point, and transmits movement path information to the locator so that the locator moves to the ball point while detecting the position of the locator by the camera sensing system.

Preferably, the locator is configured to be implemented in the form of either a driving means that operates on the field or a flying means that flies on the field, wherein the locator is configured to receive the movement path information in real time from the controller via wireless communication and move along the movement path, wherein the locator is configured to hold a golf ball or a marker and, when the locator reaches the ball point transmitted by the controller, put down the golf ball or marker.

Preferably, the camera sensing system is configured to divide the field into preset sizes and each of the plurality of cameras is set to detect each of the divided regions.

Preferably, the camera sensing system includes the plurality of cameras and a sensing processor that detects an object corresponding to the locator from images acquired by each of the plurality of cameras, calculates position coordinate information of the locator on the field, and transmits the calculated position coordinate information to the controller.

Preferably, the camera sensing system is configured to analyze images acquired by each of the plurality of cameras to calculate position coordinate information of the locator detected on the field and transmit the calculated position coordinate information to the controller, and the controller is configured to calculate movement path information from the transmitted position coordinate of the locator to the position coordinate of the ball point and transmit the calculated movement path information to the locator.

Preferably, the hybrid golf system further comprises a locator station provided on one side of the field, and configured to dock the locator to charge the docked locator and supply a golf ball or a marker to the locator, wherein the locator is configured to place the golf ball or marker at the ball point on the field and then return to the locator station.

Preferably, the controller is configured to calculate movement path information from the position of the locator station to the position of the ball point when the locator is docked to the locator station and transmit the information to the locator, and the controller is configured to calculate movement path information from the position of the locator detected by the camera sensing system to the position of the ball point when the locator is not docked to the locator station and transmit the information to the locator.

In accordance with another aspect of the present invention, there is provided a method for positioning a golf ball or marker at a ball point on a field in a hybrid golf system comprising the field provided so that a user can play actual golf and a screen golf module provided on one side of the field so that the user can play golf in a virtual golf course, the method comprising: calculating a position on the field corresponding to a ball position on the virtual golf course of the user played through the screen golf module as a ball point on the field; detecting a locator that moves on the field and carries a golf ball or marker by a camera sensing system having a plurality of cameras arranged to detect the field, calculating position information of the locator, and calculating movement path information from the position of the locator to the ball point; and transmitting the calculated movement path information to the locator so that the locator moves along the movement path and place the golf ball or marker at the ball point.

Preferably, the method for positioning a golf ball or marker at a ball point on a field in a hybrid golf system further comprises: calculating position coordinate information of the locator detected on the field by analyzing images acquired by each camera of the camera sensing system; determining whether the position coordinate of the locator has deviated from the calculated movement path, and calculating a new movement path to the ball point from the position coordinate of the locator and transmitting the new movement path to the locator if the position coordinate of the locator has deviated from the movement path.

### Advantageous Effects

A hybrid golf system and a method for locating golf ball or marker at ball point on the real field in the hybrid golf system have the effect that enables stable hybrid golf play and improves user convenience by enabling detection and control through a camera sensing system so that, when playing on an actual field following play on a virtual golf course using a screen golf system in the hybrid golf system, a locator can position a golf ball or a marker at a ball point on the field that corresponds to a ball position on the virtual golf course.

### DESCRIPTION OF DRAWINGS

FIG. 1 is a view showing the configuration of a hybrid golf system according to an embodiment of the present invention.

FIG. 2 is a block diagram showing a control system of the hybrid golf system shown in FIG. 1.

FIG. 3 is a view showing that a user plays virtual golf in a screen golf module shown in FIG. 1 while viewing an image projected on a screen.

FIG. 4 is a view illustrating an example of a method in which a field is detected by a camera sensing system of the hybrid golf system according to an embodiment of the present invention.

FIG. 5 is a flowchart showing a method for positioning a golf ball or a marker on a ball point on the field in the hybrid golf system according to an embodiment of the present invention.

FIGS. 6 and 7 are views showing a locator moving to a specific ball point, placing a golf ball or a marker down, and returning to a locator station according to an embodiment of the present invention.

### BEST MODE

A hybrid golf system and a method for locating golf ball or marker at ball point on the real field in the hybrid golf system according to the present invention will be described in detail with reference to the drawings.

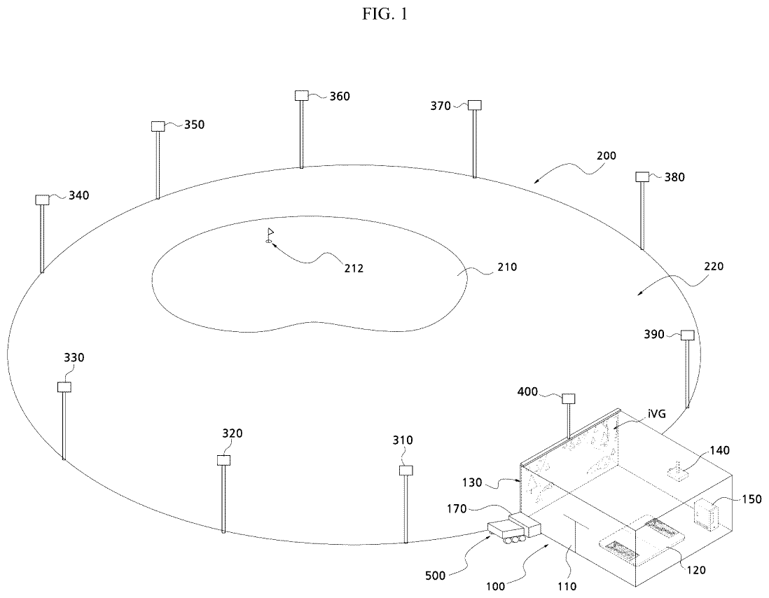

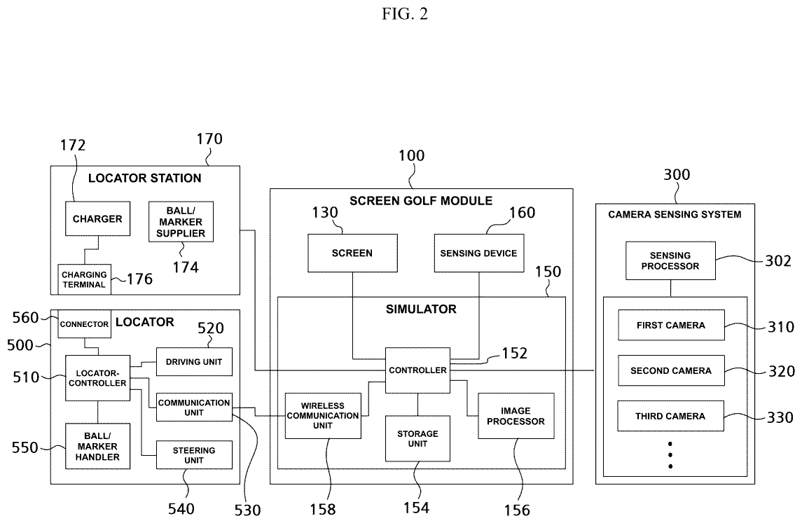

First, the configuration of a hybrid golf system according to an embodiment of the present invention will be described with reference to FIGS. 1 and 2.

FIG. 1 is a view showing the configuration of a hybrid golf system according to an embodiment of the present invention, and FIG. 2 is a block diagram showing a control system of the hybrid golf system shown in FIG. 1.

As shown in FIG. 1, the hybrid golf system according to an embodiment of the present invention may include a field 200 configured to allow a user to play real golf thereon and a screen golf module 100 having a virtual golf simulation apparatus configured to allow the user to play golf on a virtual golf course therethrough.

In addition, the hybrid golf system according to an embodiment of the present invention may include a camera sensing system 130 including a plurality of cameras 310 to 150 configured to detect the field 200, and a locator 500 that positions a golf ball or a marker at a user's ball point while moving on the field 200.

The screen golf module 100 includes the configuration of a general screen golf system, i.e., the configuration of a virtual golf simulation apparatus that enables a user to play virtual golf by projecting a virtual golf course image onto a screen in front of the user, when the user hits a ball toward the screen in a tee box 120, sensing the same through a sensing device 160, and implementing a simulation image iVG of a virtual ball moving on the virtual golf course image based on the sensing result.

The screen golf module 100 may be configured in the form of a box or a booth having an entrance 110 on one side, and may be configured such that all surfaces are closed or some of the surfaces are open.

The screen golf module 100 may be configured to include a screen 130 on the side facing the field 200.

The screen 130 is a component configured to allow an image of a virtual golf course output by an image output device 140 (e.g., a beam projector) provided in the screen golf module 100 and the simulation image iVG on the virtual golf course to be projected thereon such that the images are provided to the user.

Meanwhile, the field 200 may be configured to form the topography of a part of one hole of a real golf course, may include a green 210 and a hole cup 212, as shown in FIG. 1, and may include a fairway around the green 210 and surrounding areas 220, such as a rough and a bunker, such that the user can actually play approach shots and putts.

In the hybrid golf system according to an embodiment of the present invention, the user may play part of a golf game on the virtual golf course in the screen golf module 100 and may play the remainder of the golf game on the field 200.

For example, in the case of golf play on a par-4 hole, virtual golf may be played on a virtual golf course of the par-4 hole in the screen golf module 100 (golf play in which the user plays a golf shot toward the screen in the tee box and the sensing device senses the hit ball for simulation), and golf play may be resumed on the par-4 hole on the field 200 after the user directly moves to the field 200.

In addition, for example, a tee shot and a second shot on the par-4 hole may be taken as virtual golf play on the virtual golf course in the screen golf module 100, and a third shot (approach shot) may be taken and a putt may be made as actual golf play on the field 200 after the user moves from the screen golf module 100 to the field 200.

As shown in FIG. 1 and FIG. 2, the simulator 150 provided inside the screen golf module 100 includes a controller 152, an image processor 156, and a storage unit 154 for storing data. The controller 152 is configured to receive sensing data from a sensing device 160, and the controller 152 can control a locator 500 moving on the field through a wireless communication unit 158.

The controller 152 as described above calculates a position on the field corresponding to a ball position on a virtual golf course of a user who has played through the simulator 150 as a ‘ball point’. The controller can be configured to detect the position of the locator 500 through a camera sensing system 300 and transmit movement path information to the locator 500 so that the locator 500 moves to each user's 'ball point'.

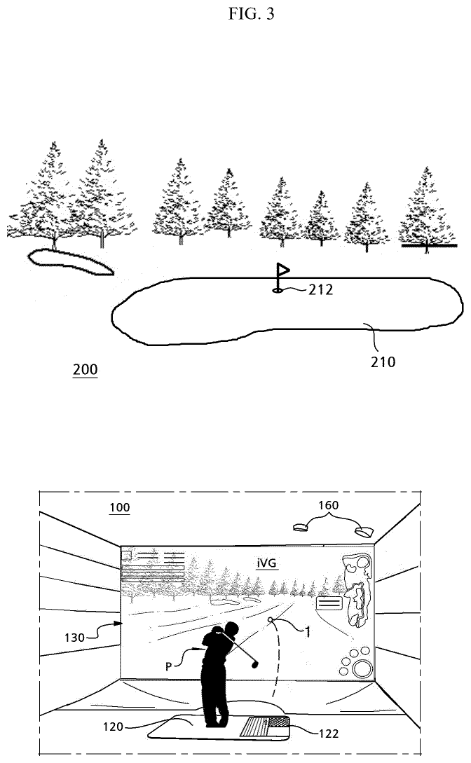

FIG. 3 is a view showing that a user P plays virtual golf in the screen golf module 100 shown in FIG. 1 while viewing the image iVG projected on the screen 130.

The sensing device 160 may be implemented as a camera-based device configured to sense the movement of at least one of a golf club and a golf ball according to a user's golf swing. When the user P hits the golf ball placed on a golf mat 122 in the tee box 120 within the field of view of the camera, the sensing device 160 captures and collects images of the hit golf ball 1, performs analyses such as image processing on the collected images, calculates sensing information such as movement parameters for the movement of the golf ball 1, and transmits the same to the controller 152.

A manipulation device (not shown) may be provided as a means for the user to manipulate in order to set a virtual golf simulation environment or in order to adjust aiming or the like in the course of a virtual round of golf.

The storage unit 154 stores all data necessary for image realization of the virtual golf simulation, and stores data about a virtual golf course realized by imaging a real golf course and data about topography information of the virtual golf course, whereby it is possible to provide data capable of realizing a virtual environment that enables the user to play a virtual round of golf on a virtual golf course selected by the user.

The storage unit 154 may be configured to store all of various data regarding the virtual golf course, or may be configured to receive various data regarding the virtual golf course from a server (not shown) over a network and to temporarily store the same.

The image processor 156 performs information processing to realize an image of the virtual golf course on the screen using data about the virtual golf course stored in the storage unit 154, and performs information processing to realize an image in which the trajectory of the golf ball hit by the user is simulated on the virtual golf course.

The image information processed by the image processor 156 is projected on the screen 130 through the image output device 140, which may be implemented as a projector or the like, such that the user P can view the image iVG projected on the screen 130.

The image processor 156 may be implemented as one modularized part configured to perform an image processing function in one independent device, or may be implemented as one independent device.

The controller 152 is a component configured to control all processing for the virtual golf simulation, and performs various operations and controls to simulate the movement of the virtual ball on the virtual golf course based on the sensing information about the moving golf ball extracted according to the sensing result of the sensing device 160 and physics engine. Based on these various operations and controls, the image iVG in which the virtual ball is simulated on a virtual golf course according to the sensing results of the sensing device and the physics engine may be realized.

The controller 152 may determine whether the requirement for the user to perform field play on the field is satisfied in the process of playing virtual golf on the virtual golf course, and if the requirement for field play is satisfied, the controller 152 may provide image/voice guidance through the screen image iVG for the user to move to the field 200 and perform field play.

In the case of a plurality of users playing a round of golf together, field play as described above may be initiated when all users' balls (virtual balls in an image) are located within a predetermined range on the virtual golf course, such as within a predetermined radius relative to a hole cup (a hole cup on a green of the virtual golf course).

When field play is initiated as described above, the controller 152 of the simulator 150 may perform control such that each camera of the camera sensing system 300 is ready for sensing, and may calculate the ball point on the field corresponding to each user's ball position on the virtual golf course when field play is initiated.

That is, the controller 152 may use the field 200 as a coordinate space and may calculate coordinate information of the ball point corresponding to the ball position of each user in the coordinate space.

Here, “ball position” refers to the position of each user's ball (ball in the image) on the virtual golf course, and “ball point” refers to the position coordinates in the coordinate space of the field 200 corresponding to the position of each ball.

Meanwhile, as shown in FIGS. 1 and 2, the camera sensing system 300 of the hybrid golf system according to the embodiment of the present invention may include a plurality of cameras 310 to 400 installed around the field 200 so as to be disposed at predetermined intervals and a sensing processor 302.

The plurality of cameras 310 to 400 is connected to the sensing processor 302, as shown in FIG. 2, and the sensing processor 302 may detect objects on the field 200 from images acquired by the plurality of cameras 310 to 400. Accordingly, the camera sensing system can detect an object corresponding to the locator 500 moving or stopped on the field 200 and calculate the position coordinate information of the locator 500 on the field 200 and transmit the position coordinate of the locator to the controller 152.

That is, the camera sensing system 300 may sense the movement of the locator 500 while monitoring the field 200 using images acquired by each of the plurality of cameras 310 to 400 and allow the locator 500 to move to the correct position.

The camera sensing system 300 may be configured to divide the field 200 into predetermined sizes, and each of the cameras installed around the field 200 may be configured to detect a corresponding one of the divided regions.

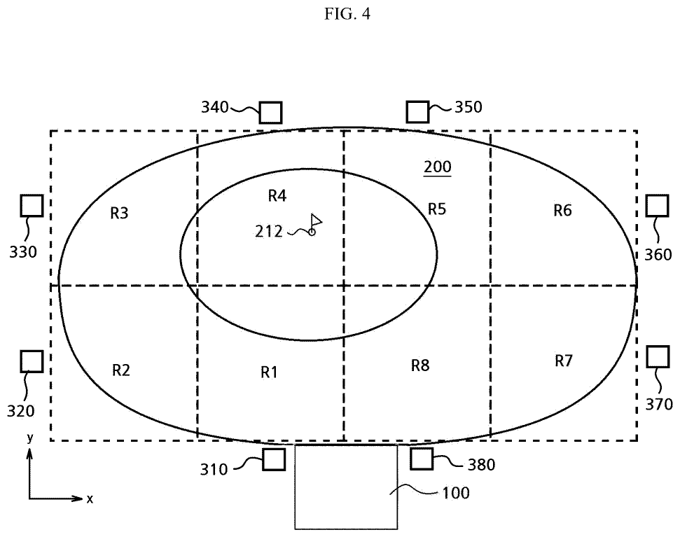

For example, as shown in FIG. 4, the field 200 may be divided into a first divided region R1, a second divided region R2, a third divided region R3, a fourth divided region R4, a fifth divided region R5, a sixth divided region R6, a seventh divided region R7, and an eighth divided region R8, wherein the first divided region R1 may be detected by a first camera 310, the second divided region R2 may be detected by a second camera 320, the third divided region R3 may be detected by a third camera 330, the fourth divided region R4 may be detected by a fourth camera 340, the fifth divided region R5 may be detected by a fifth camera 350, the sixth divided region R6 may be detected by a sixth camera 360, the seventh divided region R7 may be detected by a seventh camera 370, and the eighth divided region R8 may be detected by an eighth camera 380.

The sensing processor 302 of the camera sensing system 300 may convert each camera coordinate system of the image acquired by each of the above-described plurality of cameras into a coordinate system for the entire field (200) as shown in FIG. 4, and may calculate coordinate information on the position of the ball point or the position of the locator in the coordinate space for the entire field 200 and transmit it to the controller.

That is, each camera of the camera sensing system 300 may detect each responsible divided region using the coordinate system of the corresponding camera, and the sensing processor 302 may calculate coordinate information of a specific position according to the entire field coordinate system by making the entire field 200 into one coordinate system (x-y coordinate system as shown in FIG. 4) from the image transmitted by each camera.

For example, if the locator is detected through an image acquired by the first camera 310 in the R1 region, the sensing processor may convert the image acquired by the first camera 310 into an x-y coordinate system, which is a coordinate system of the entire field, to calculate the position coordinate information of the locator.

Meanwhile, as shown in FIGS. 1 and 2, the hybrid golf system according to an embodiment of the present invention may include a locator 500 that may carry and place a golf ball or a marker at a specific position on the field.

The locator 500 may be implemented in the form of a driving means (e.g., a mini vehicle, etc.) that operates on the field 200 or a flying means (e.g., a drone, etc.) that flies and moves on the field.

The locator 500 may include a driving unit 520 that enables movement (including flight) and a steering unit 540 that can adjust the movement direction of the locator 500. The locator may be configured to receive a ‘golf ball or marker’ to be carried, and may include a ball/marker handler 550 capable of handling the golf ball or marker so as to place the received golf ball or marker at a specific position (i.e., the user's ball point).

Since such a configuration of the locator itself has already been disclosed as a conventional technology, a detailed description thereof will be omitted.

The locator 500 may include a communication module 530 capable of transmitting and receiving data wirelessly with the wireless communication unit 158 of the simulator 150. Accordingly, the locator can receive movement path information from the controller 152 of the simulator 150 via wireless communication, and the locator-controller 510 can control the driving unit 520 and the steering unit 540 according to the movement path information received via the communication module 530 so that the locator 500 can move to a position determined by the movement path.

That is, the locator 500 is configured to receive movement path information in real time from the controller 152 via wireless communication and move along the path, and the locator is configured to hold a golf ball or a marker and put down the golf ball or marker it holds when it reaches a ball point along the path, which can be controlled by the locator-controller 510.

In addition, as shown in FIGS. 1 and 2, a locator station 170 may be provided on one side of the field 200 so that the locator 500 may be docked to the locator station 170.

The locator station 170 may be provided with a ball/marker supplier 174, a charger 172, and a charging terminal 176 as shown in FIG. 2, and when the locator 500 is docked to the locator station 170, the connection unit 560 of the locator 500 may be connected to the charging terminal 176 of the locator station 170 so that the locator 500 may be charged. The ball/marker supplier 174 of the locator station 170 may be configured to supply golf balls or markers to the locator 500.

The locator 500 may move on the field 200, place a golf ball or a marker at a designated position, and then return to the locator station 170 and wait in a docked state until moving to the next position, as shown in FIG. 1.

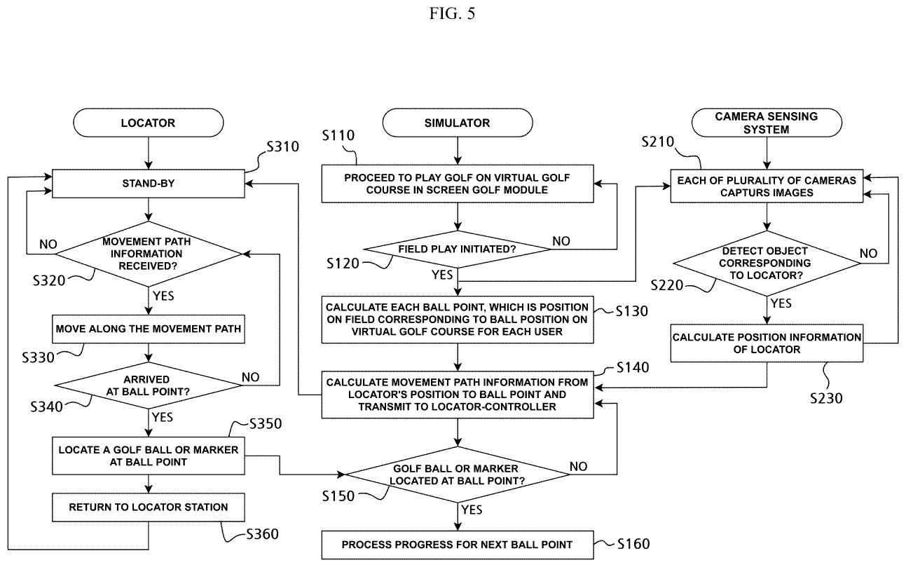

Meanwhile, a method for locating a golf ball or a marker at the ball point on the real field in the hybrid golf system according to an embodiment of the present invention will be described with reference to FIGS. 5 to 7.

FIG. 5 is a flowchart showing a method for positioning a golf ball or a marker on a ball point on the field in the hybrid golf system according to an embodiment of the present invention.

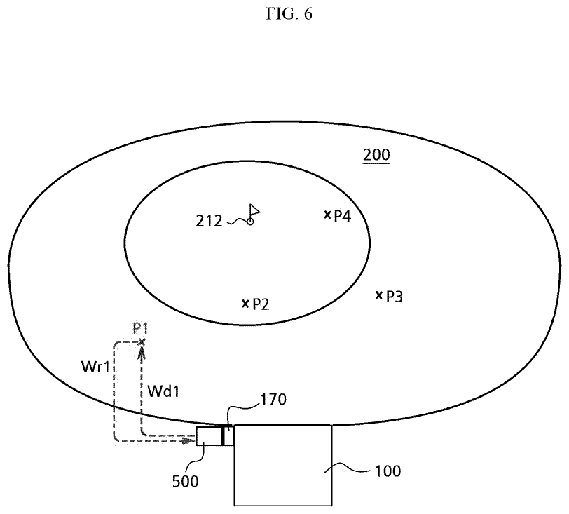

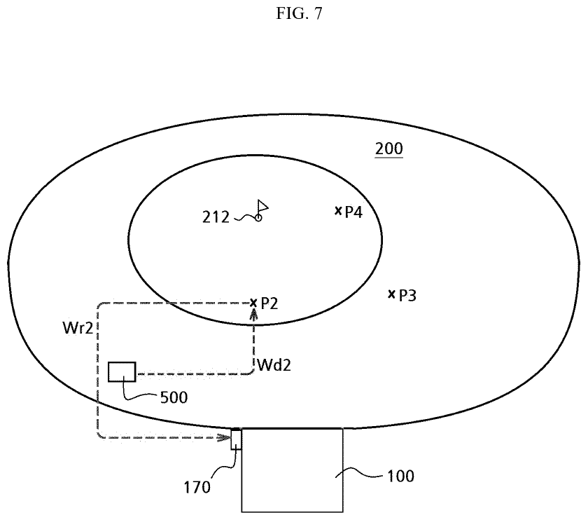

FIGS. 6 and 7 are views showing a locator moving to a specific ball point, placing a golf ball or a marker down, and returning to a locator station according to an embodiment of the present invention.

As shown in FIG. 5, one or more users first use the screen golf module to play golf on a virtual golf course (S110).

During the process of playing virtual golf in the screen golf module, if the field play initiation requirement is met, the field play is started (S120), and when the field play is started, the users can move from the screen golf module to the field and play golf on the field.

For example, when four users play virtual golf on hole 1 of the virtual golf course, if all four users land the ball on the green of hole 1 or settle the ball within a predetermined range around the green, the field play initiation requirement is met and the field play can be started.

When the field play is started, the controller operates the camera sensing system, and each of the plurality of cameras of the camera sensing system acquires images for each corresponding divided region on the field (S210).

Meanwhile, when the field play is started, the controller calculates the ‘ball point’, which is the position on the field corresponding to the ball position on the virtual golf course of each user (S130).

Since the green and its surrounding area on the virtual golf course has a different terrain from the real field formed in front of the screen golf module, the ‘ball position’ and the ‘ball point’ as described above do not exactly same, however the ‘ball position’ on the virtual golf course and the ‘ball point’ on the real field can be matched by various methods. For example, a reference position (e.g., hole cup position) may be set, and the ‘ball position’ and the ‘ball point’ can be matched by the relative positional relationship based on the reference position.

As the ‘ball position’ of the user on the virtual golf course and the ‘ball point’ on the field corresponding to the ball position are calculated in the way as described above, when the field play is started, the controller can recognize the position coordinates of the ball point of each user on the field.

Meanwhile, the camera sensing system collects and analyzes images acquired by each of the plurality of cameras, thereby detecting an object corresponding to the locator in the image (S220), and thereby calculating the position information of where the locator is located (S230).

The controller receives the position information of the locator from the camera sensing system, calculates the movement path information from the position of the locator to the ball point on the field, and transmits the calculated movement path information to the locator-controller (S140). The locator waits (S310) and when it receives the movement path information of the ball point from the controller (S320), the locator can move along the movement path (S330).

If the locator is docked to the locator station, even if the camera sensing system does not detect the locator, the controller can recognize that it is docked to the locator station, and thus the controller can calculate the movement path information from the locator station to the ball point on the field and transmit the movement path information to the locator-controller.

The locator-controller controls the locator to move along the movement path transmitted from the controller, and when the locator arrives at the ball point (S340), the locator can place the golf ball or marker it was holding at the ball point (S350) and return to the locator station (S360).

The locator-controller can notify the controller that it has placed the golf ball or marker at the ball point after placing the golf ball or marker at the ball point, and when the controller determines that the locator has placed the golf ball or marker at the ball point (S150), the controller can wait until the user makes a shot at the ball point. After the shot is made, the controller can proceed with a process of allowing the locator to place the golf ball or marker at the next ball point on the field in the same manner as described above (S160).

The controller may detect the position information of the locator in real time through the camera sensing system (S230) after transmitting the movement path information to the locator-controller according to step S140, and monitor whether the locator has deviated from the movement path during the movement process. If it is determined that the locator has deviated from the movement path through detection by the camera sensing system, the position information of the locator at that time can be identified through the camera sensing system, and the movement path to the ball point can be recalculated and transmitted to the locator-controller, thereby allowing the locator to complete the movement to the ball point.

In this regard, referring to FIG. 6, the example shown in FIG. 6 shows a case where the locator station 170 is provided on one side of the screen golf module 100 and the locator 500 is docked to the locator station 170. In FIG. 6, the ball points on the field 200 of each of the four users are illustrated (the ball point of user 1 is P1, the ball point of user 2 is P2, the ball point of user 3 is P3, and the ball point of user 4 is P4).

In FIG. 6, the camera sensing system is omitted.

As described above, the controller calculates each of the ball points P1 to P4 as a position on the field corresponding to the ball position of each user on the virtual golf course, so the controller recognizes the position coordinates of each of the ball points on the field.

The controller can control the locator to sequentially locate a golf ball or marker at each ball point according to the shot order from the position of each of the ball points P1, P2, P3 and P4.

In the example shown in FIG. 6, a shot is made at the P1 ball point that is farthest from the hole cup 212, then a shot is made at the P3 ball point, and then putting is sequentially made from the point that is farthest from the hole cup 212 on the green 210.

The controller may determine the position of the locator 500 in order to place the golf ball or marker at the P1 ball point. The controller may first determine whether the locator 500 is docked to the locator station 170. If the locator is not docked to the locator station 170, the controller can determine the position of the locator 500 through the camera sensing system.

In the example shown in FIG. 6, since the locator 500 is docked to the locator station 170, the controller can calculate the movement path Wd1 information from the position of the locator station 170 to the P1 ball point and transmit the calculated movement path to the locator-controller.

The locator-controller can receive the movement path Wd1 information to the P1 ball point and control the driving unit and the steering unit, etc. to move the locator 500 along the movement path Wd1.

The camera sensing system may detect the position of the locator 500 in real time while the locator 500 moves along the movement path Wd1 and transmits the information to the controller, so that the controller can monitor whether the locator 500 is moving correctly along the movement path Wd1.

If the locator 500 deviates from the movement path Wd1 during the movement process, the camera sensing system detects the position information of the locator 500 in real time, so that the controller calculates the movement path from the position of the locator 500 detected by the camera sensing system to the P1 ball point again and transmits the re-calculated movement path information to the locator-controller, and the locator-controller can continue to move along the re-calculated movement path.

In this way, when the locator 500 arrives at the P1 ball point, the locator-controller controls the ball/marker handler to place the golf ball or marker at the P1 ball point, and can return along the return path Wr1 from the P1 ball point position to the position of the locator station 170.

Wherein the return path Wr1 from the ball point to the locator station 170 is calculated by the controller and transmitted to the locator-controller, and the locator-controller can control to move the locator 500 to return to the locator station 170 along the transmitted return path Wr1.

Alternatively, the locator-controller may recognize map information about the field and self-calculate the return path Wr1 to return.

In this way, the controller can control the locator to move along the movement path through detection by the camera sensing system to place a golf ball or marker at the ball point, and can control the locator to return to the locator station, and in this way, the locator can place a golf ball or marker at the ball point of all users. When a golf ball is placed at the user's ball point by the locator, the user can make an approach shot or putt with the golf ball. Alternatively, the user can place the golf ball he or she has at the position of the marker placed by the locator and make an approach shot or putt. Accordingly, the user can play golf on the field stably and conveniently.

Meanwhile, as described above, the locator 500 may be processed to return to the locator station 170 after placing a golf ball or marker at the ball point, however for some reason, the locator 500 may not return to the locator station 170 and may be at any location on the field 200.

FIG. 7 shows a case where the locator 500 moves to place a golf ball or marker at the P2 ball point, which shows the locator 500 is at any location on the field 200 other than the locator station 170 and moves from that location to the P2 ball point.

Although omitted in FIG. 7, since the camera sensing system detects the position of the locator 500 in real time by using the plurality of cameras installed around the field, the controller can calculate the movement path Wd2 information from the current position of the locator 500 detected by the camera sensing system to the P2 ball point and transmit the calculated movement path to the locator-controller, and the locator-controller can control to move the locator 500 to the P2 ball point along the movement path Wd2.

If the locator 500 deviates from the movement path Wd2 during the movement process, since the camera sensing system detects the position information of the locator 500 in real time, the controller can calculate the movement path from the position of the locator 500 detected by the camera sensing system to the P2 ball point again and transmit it to the locator-controller, and the locator-controller can continue to move along the re-calculated movement path.

In this manner, when the locator 500 arrives at the P2 ball point, the locator-controller controls the ball/marker handler to place a golf ball or marker at the P2 ball point, and the controller can calculate a return path Wr2 from the P2 ball point position to the locator station 170 position and transmits it to the locator-controller, and the locator-controller can control to move the locator 500 to return to the locator station 170 along the transmitted return path Wr2.

Accordingly, as described above, the hybrid golf system and a method for locating golf ball or marker at ball point on the real field in the hybrid golf system have an advantageous effect that enables stable hybrid golf play and improves user convenience by enabling detection and control through a camera sensing system so that, when playing on an actual field following play on a virtual golf course using a screen golf system in the hybrid golf system, a locator can position a golf ball or a marker at a ball point on the field that corresponds to a ball position on the virtual golf course.

### INDUSTRIAL APPLICABILITY

A hybrid golf system and a method for locating golf ball or marker at ball point on the real field in the hybrid golf system according to the present invention can be used in industries related to golf and the so-called screen golf industry that allows users to enjoy playing golf based on a virtual golf simulation.

1. A hybrid golf system comprising:
a screen golf module that allows a user to play golf in a virtual golf course and is provided on one side of a field on which the user plays actual golf;
a simulator provided in the screen golf module that implements a virtual golf simulation image according to the virtual golf course and the user's golf play;
a camera sensing system including a plurality of cameras provided to detect the field;
a locator that moves on the field and locates a golf ball or a marker at a user's ball point; and
a controller that calculates a position on the field corresponding to a ball position on the virtual golf course of the user played through the simulator as the ball point, and transmits movement path information to the locator so that the locator moves to the ball point while detecting the position of the locator by the camera sensing system.

2. The hybrid golf system according to claim 1, wherein the locator is configured to be implemented in the form of either a driving means that operates on the field or a flying means that flies on the field, wherein the locator is configured to receive the movement path information in real time from the controller via wireless communication and move along the movement path, wherein the locator is configured to hold a golf ball or a marker and, when the locator reaches the ball point transmitted by the controller, put down the golf ball or marker.

3. The hybrid golf system according to claim 1, wherein the camera sensing system is configured to divide the field into preset sizes and each of the plurality of cameras is set to detect each of the divided regions.

4. The hybrid golf system according to claim 1, wherein the camera sensing system includes the plurality of cameras and a sensing processor that detects an object corresponding to the locator from images acquired by each of the plurality of cameras, calculates position coordinate information of the locator on the field, and transmits the calculated position coordinate information to the controller.

5. The hybrid golf system according to claim 1, wherein the camera sensing system is configured to analyze images acquired by each of the plurality of cameras to calculate position coordinate information of the locator detected on the field and transmit the calculated position coordinate information to the controller, and the controller is configured to calculate movement path information from the transmitted position coordinate of the locator to the position coordinate of the ball point and transmit the calculated movement path information to the locator.

6. The hybrid golf system according to claim 1, further comprising a locator station provided on one side of the field, and configured to dock the locator to charge the docked locator and supply a golf ball or a marker to the locator, wherein the locator is configured to place the golf ball or marker at the ball point on the field and then return to the locator station.

7. The hybrid golf system according to claim 6, wherein the controller is configured to calculate movement path information from the position of the locator station to the position of the ball point when the locator is docked to the locator station and transmit the information to the locator, and
wherein the controller is configured to calculate movement path information from the position of the locator detected by the camera sensing system to the position of the ball point when the locator is not docked to the locator station and transmit the information to the locator.

8. A method for positioning a golf ball or marker at a ball point on a field in a hybrid golf system comprising the field provided so that a user can play actual golf and a screen golf module provided on one side of the field so that the user can play golf in a virtual golf course, the method comprising:
calculating a position on the field corresponding to a ball position on the virtual golf course of the user played through the screen golf module as a ball point on the field;
detecting a locator that moves on the field and carries a golf ball or marker by a camera sensing system having a plurality of cameras arranged to detect the field, calculating position information of the locator, and calculating movement path information from the position of the locator to the ball point; and
transmitting the calculated movement path information to the locator so that the locator moves along the movement path and place the golf ball or marker at the ball point.

9. The method according to claim 8, further comprising:
calculating position coordinate information of the locator detected on the field by analyzing images acquired by each camera of the camera sensing system;
determining whether the position coordinate of the locator has deviated from the calculated movement path, and
calculating a new movement path to the ball point from the position coordinate of the locator and transmitting the new movement path to the locator if the position coordinate of the locator has deviated from the movement path.
